(19) United States
(12) Patent Application Publication
(10) Pub. No.: US 2012/0123979 A1
(43) Pub. Date: May 17, 2012

(54) PERSON EVALUATION DEVICE, PERSON EVALUATION METHOD, AND PERSON EVALUATION PROGRAM

(75) Inventors: Taiji OKAMOTO, Fujisawa (JP); Hiroshi Yamakawa, Kawasaki (JP); Nobuo Watanabe, Kawasaki (JP)

(73) Assignee: FUJITSU LIMITED, Kawasaki (JP)

(21) Appl. No.: 13/331,740

(22) Filed: Dec. 20, 2011

Related U.S. Application Data
(63) Continuation of application No. PCT/JP2009/061520, filed on Jun. 24, 2009.

(51) Int. Cl. G06F 15/18

(52) U.S. Cl. 706/12

(57) ABSTRACT

A person evaluation device includes a collecting unit that collects event data in which activities performed by members are recorded; a creating unit that creates a combination of evaluation programs each of which calculates an evaluation value of a person to be evaluated in accordance with a value that is set in a predetermined item contained in evaluation items contained in the event data, a calculating unit that calculates a coverage percentage that represents a percentage that is used to calculate the evaluation value by at least one evaluation program in which event data, from among the collected event data, related to a member associated with the person to be evaluated is included in the created combination, and an output unit that outputs information related to the evaluation program included in the combination that is selected in accordance with the calculated coverage percentage.

### CROSS-REFERENCE TO RELATED APPLICATION

This application is a continuation of International Application No. PCT/JP2009/061520, filed on Jun. 24, 2009, the entire contents of which are incorporated herein by reference.

### FIELD

The embodiment discussed herein is directed to a person evaluation device, a person evaluation method, and a person evaluation program.

### BACKGROUND

Over the past few years, the Internet has led to the spread of various activities on various membership sites, such as auction sites, social network service (SNS) sites, or the like. Furthermore, the use is spreading of services, such as OpenID, that enable more than one membership site to be accessed with a common member ID.

Against this background, there is a strong demand to implement a technology for properly evaluating a person involved with a network. For example, in order to avoid problems, such as a deception, a user who attempts to make a successful bid for a product at an online auction site wants to check whether the exhibitor of the product is a reliable person.

Conventionally, systems are used on online auction sites, in which an exhibitor and a winning bidder mutually make an evaluation in accordance with past transaction results and reference can be made to the obtained result. However, activities on specific online auction sites are only some of the activities in which the exhibitor on a network is involved. Accordingly, it is difficult to properly evaluate whether the exhibitor is a reliable person only from his/her activity on the particular online auction site in which the product provided by the exhibitor is displayed.

There is a known technology for properly and precisely evaluating a person by, for example, selecting an evaluation method from among various types of evaluation methods and performing an evaluation in accordance with the selected evaluation method (see Japanese Laid-open Patent Publication No. 2004-054393).

However, even when using the conventional technology for evaluating a person, if there are many evaluation methods, the difference between the coverage of events used in each evaluation method is not taken into consideration. Accordingly, there is a problem in that it is difficult to determine which evaluation technique to select in order to obtain more reliable coverage and to obtain fairer and reliable evaluation values.

### SUMMARY

According to an aspect of an embodiment of the invention, a person evaluation device includes a collecting unit that collects, from a plurality of membership sites, event data in which activities performed by members on the membership sites are recorded, a combination candidate creating unit that creates a combination of evaluation programs each of which calculates an evaluation value of a person to be evaluated in accordance with a value that is set in a predetermined item contained in evaluation items contained in the event data, a coverage percentage calculating unit that calculates, for each combination, a coverage percentage that represents a percentage that is used to calculate the evaluation value by at least one evaluation program in which event data, from among the event data collected by the collecting unit, related to a member associated with the person to be evaluated is included in the combination created by the combination candidate creating unit, and a selection result output unit that outputs information related to the evaluation program included in the combination that is selected in accordance with the coverage percentage calculated by the coverage percentage calculating unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram illustrating the configuration of a person evaluation device;

FIG. 2A is a schematic diagram illustrating an example of site information;

FIG. 2B is a schematic diagram illustrating an example of site information;

FIG. 3 is a schematic diagram illustrating an example of person information;

FIG. 4 is a schematic diagram illustrating an example of event information;

FIG. 5 is a schematic diagram illustrating an example of evaluation program specification information;

FIG. 6A is a flowchart illustrating the flow of a combination selecting process;

FIG. 6B is a flowchart illustrating the flow of an evaluation executable determining process;

FIG. 7 is a schematic diagram illustrating an example of the data structure used in the combination selecting process; and

FIG. 8 is a functional block diagram illustrating a computer that executes a program.

### DESCRIPTION OF EMBODIMENT

Preferred embodiments of the present invention will be explained with reference to accompanying drawings. The present invention is not limited to the embodiment.

First, the person evaluation method according to the embodiment will be described. In the person evaluation method according to the embodiment, person evaluation is performed in accordance with activity logs (hereinafter, referred to as an “event”) collected from a plurality of membership sites. Various types of evaluation techniques for evaluating a person are prepared in accordance with the purpose. Evaluation items used to evaluate each of the evaluation techniques are previously determined.

To fairly evaluate persons, it is conceivable to perform evaluation using all of the evaluation techniques; however, the number of evaluation results increases as the number of types of evaluation techniques increases. Accordingly, it is difficult to properly use the evaluation results. Furthermore, if a lot of evaluation results are referred to, there is a problem in that personal information, such as ages, occupations, and dwelling places, which is, in principle, concealed by a person to be evaluated, is easily assumed.

Accordingly, in the person evaluation method according to the embodiment, a combination that can be used to most fairly evaluate a person to be evaluated is selected from among combinations of evaluation techniques including a predetermined number of evaluation techniques. Specifically, for combinations of the evaluation techniques, a coverage percentage, which is a percentage of events provided by a person to be evaluated is used for the evaluation, is calculated and then a combination having the highest coverage percentage is selected as a combination that can be used to most fairly evaluate the person to be evaluated.

A high coverage percentage means that there is a high possibility that an event that is advantageous for a person to be evaluated and an event that is disadvantageous for the person to be evaluated are contained in a balanced manner. Accordingly, by selecting a combination of evaluation techniques having a high coverage percentage, a person to be evaluated can be fairly evaluated without using all of the combinations of the valuation techniques.

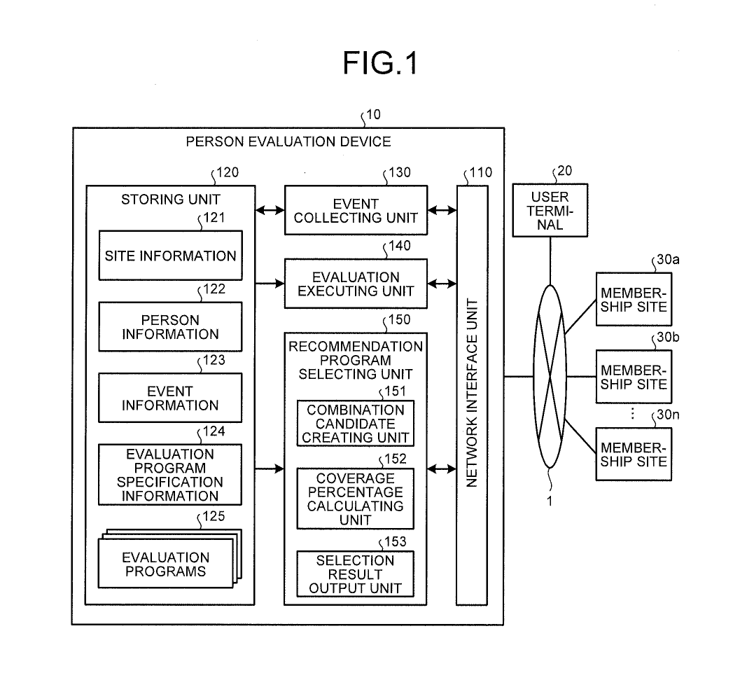

In the following, a person evaluation device 10 that performs the person evaluation method according to the embodiment will be described. FIG. 1 is a block diagram illustrating the configuration of the person evaluation device 10. As illustrated in FIG. 1, the person evaluation device 10 is connected to a user terminal 20 and membership sites 30a to 30n via a network 1, such as the Internet.

The user terminal 20 is a terminal device, such as a personal computer, operated by a user that attempts to evaluate, using the person evaluation device 10, a person to be evaluated. The membership sites 30a to 30n are server devices that provide membership services, such as online auctions or SNSes.

The person evaluation device 10 is an information processing apparatus that executes the person evaluation method according to the embodiment and includes a network interface unit 110, a storing unit 120, an event collecting unit 130, an evaluation executing unit 140, and a recommendation program selecting unit 150. The network interface unit 110 performs various controls of the communication with the user terminal 20 or with the membership sites 30a to 30n via the network 1.

The storing unit 120 is a storing unit, such as a hard disk drive, that stores various kinds of information. The storing unit 120 stores therein site information 121, person information 122, event information 123, evaluation program specification information 124, a plurality of evaluation programs 125, and the like.

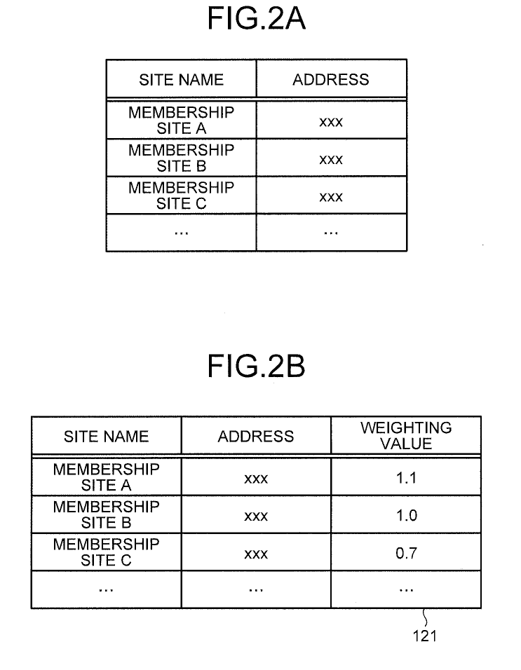

The site information 121 is information related to the membership sites 30a to 30n. An example of the site information 121 is illustrated in FIG. 2A. As illustrated in FIG. 2A, the site information 121 has items, such as a site name and an address. Data is stored for each membership site. The site name is a name of the membership site. The address is a network address that is used to access the membership site.

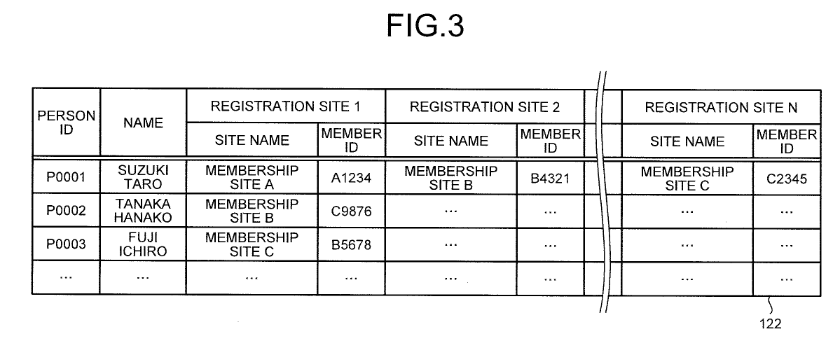

The person information 122 is information related to persons registered as members in the membership sites 30a to 30n. An example of the person information 122 is illustrated in FIG. 3. As illustrated in FIG. 3, the person information 122 has items, such as a person ID, a name, and registration sites 1 to N. Data is stored for each person. The person ID is an identification number for specifying a person. The person ID may also be an identification number that is uniquely allocated by the person evaluation device 10 or may also be an identification number, such as an OpenID, that can be commonly used at a plurality of membership sites. The name is a name of a person.

The registration sites 1 to N are items related to registration sites in which a person is registered as a member. Each of the registration sites 1 to N has a sub item, such as a site name and a member ID. The site name is a name of the registration site in which a person is registered as a member and corresponds to the site name contained in the site information 121. The member ID is an identification number of a person on a membership site.

Not all of the items are set in the registration sites 1 to N. The number of items corresponding to the number of registration sites in which persons are registered as members is set in the registration sites 1 to N. The contents stored in the registration sites 1 to N may be set in accordance with, for example, self-reported information offered by a person, or may also be automatically collected using, as a key, a common identification number, such as an OpenID; payment information, such as a credit number; an address; or the like.

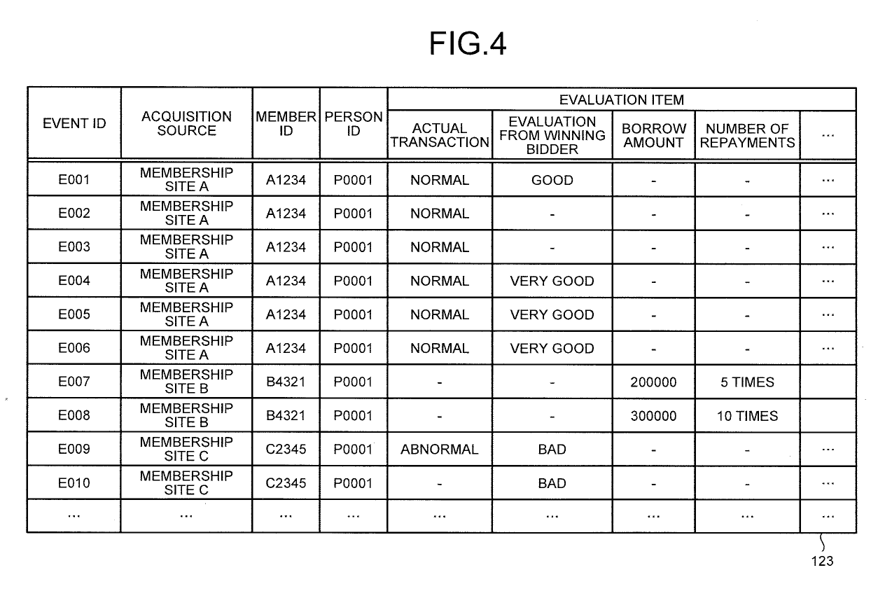

The event information 123 is information in which various events collected from the membership sites 30a to 30n are formatted in a predetermined form. An example of the event information 123 is illustrated in FIG. 4. As illustrated in FIG. 4, the event information 123 has items, such as an event ID, an acquisition source, a member ID, and a person ID, and also has various evaluation items. Data is stored therein for each event.

The event ID is an identification number for identifying an event. The acquisition source is a name of a membership site of an acquisition source of an event. The acquisition source corresponds to the site name of the site information 121. The member ID is an identification number of a person who performs an activity associated with an event at the membership site corresponding to the acquisition source of the event provided by the person. The member ID is associated with one of the member IDs stored in the registration sites 1 to N. The person ID is an identification number of a person who performs an activity corresponding to an event in the person evaluation device 10. The person ID corresponds to the person ID stored in the person information 122.

The evaluation item is an item indicating the content of the collected event and includes items, such as actual transaction, evaluation from a winning bidder, a borrow amount, the number of repayments, and the like. Not all of the evaluation items are set in the event information 123. For example, in accordance with the rule previously defined for each type of event, only items that can be set using the content of the event is set in the evaluation item.

In the following, events collected from the membership sites 30a to 30n will be described. In accordance with the type of service provided, the membership sites 30a to 30n record, as an event, an activity performed by a member and information thereon.

For example, for an activity in which a member exhibits a product, a membership site that provides an auction service records, as an event, the type of the exhibited product, the number of bids, a contract price, the actual transaction, evaluation obtained from the winning bidder, and the like. Furthermore, for an activity in which a member wins a bid, a membership site that provides an auction service records, as an event, the type of the sold product, a contract price, the actual transaction, evaluation obtained from an exhibitor, and the like.

Furthermore, for an activity in which a member comments on a diary written by another member, a membership site that provides an SNS service records, as an event, whether an authorization for opening a comment to the public is accepted or whether the comment is deleted. Furthermore, for an activity in which a member gets a cash advance, a membership site that provides a financial service records, as an event, a borrow amount, and the number of repayments.

Then, when acquiring an event related to an exhibit from a membership site that provides an auction service, the person evaluation device 10 sets the actual transaction and evaluation obtained from a winning bidder in the items of the actual transaction and the evaluation obtained from a winning bidder, respectively, that are stored in the evaluation item. Furthermore, when acquiring an event related to a cashing from a membership site that provides a financial service, the person evaluation device 10 sets the borrow amount and the number of repayments in the items of the borrow amount and the number of repayments, respectively, that are stored in the evaluation item.

Even when, for example, acquiring an event related to an exhibit from a membership site, the actual transaction or evaluation from winning bidder may sometimes not be set. In such a case, the corresponding item has not been set.

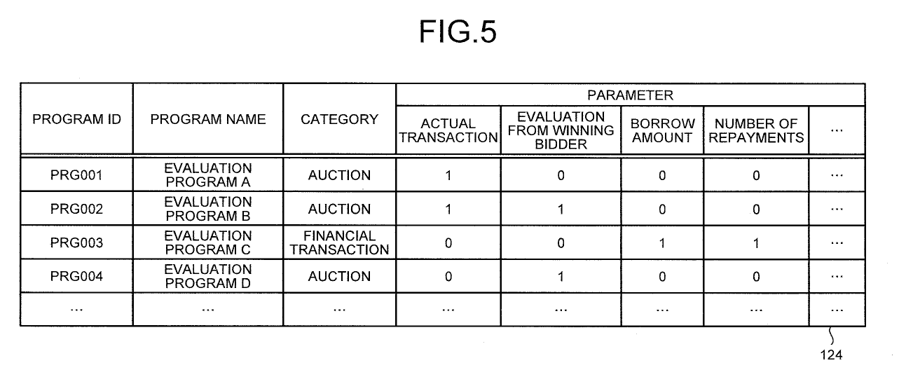

The evaluation program specification information 124 is information related to specifications of the evaluation programs 125. An example of the evaluation program specification information 124 is illustrated in FIG. 5. As illustrated in FIG. 5, the evaluation program specification information 124 has items, such as a program ID, a program name, a category, and a parameter. Data is stored for each evaluation program 125.

The program ID is a identification number for identifying the evaluation programs 125. The program name is a name of each of the evaluation programs 125. The category is a field in which the evaluation programs 125 evaluate a person. For example, if the evaluation program 125 evaluates an activity performed by a person using an auction service, an “auction” is set as a category. If an evaluation program 125 evaluates an activity performed by a person using a financial service, a “financial transaction” is set as a category.

The parameter indicates an evaluation item that is stored in the event information 123 and is used to evaluate a person by the evaluation program 125. The parameter has sub items associated with each of the evaluation items stored in the event information 123. For each of the sub items stored in the parameter, if an evaluation program 125 uses an evaluation item associated with the evaluation item stored in the event information 123, “1” is set, and, if not, “0” is set.

For example, for data indicated in the first line of the evaluation program specification information 124 illustrated in FIG. 5, “1” is set only in the sub item of the “actual transaction”. This indicates that an evaluation program 125 associated with the data indicated in the first line evaluates a person by using only a value of the evaluation item of the “actual transaction” stored in the event information 123.

Furthermore, for data indicated in the second line of the evaluation program specification information 124 illustrated in FIG. 5, “1” is set in the sub items of the “actual transaction” and the “evaluation from a winning bidder”. This indicates that an evaluation program 125 associated with the data indicated in the second line evaluates a person by using the evaluation items of the “actual transaction” and the “evaluation from a winning bidder” stored in the event information 123.

The evaluation programs 125, which corresponds to the evaluation technique described above, are programs used to evaluate a person in accordance with unique specifications. Each of the evaluation programs 125 extracts, from the event information 123, data in which a person ID matches a person ID of a person to be evaluated and a value is set in an evaluation item that is needed to calculate an evaluation value. Then, the evaluation programs 125 performs a data process, using a predetermined logic, on a value that is set in the evaluation item of the extracted data and outputs an evaluation value that corresponds to an evaluation result.

In accordance with addresses registered in the site information 121, the event collecting unit 130 collects events from the membership sites 30a to 30n, formats the events, and stores them in the event information 123. When storing the collected events in the event information 123, the event collecting unit 130 checks acquisition sources of the events and member IDs contained in the event against the site names and the member IDs contained in the person information 122 and specifies person IDs. The collecting of the events may be regularly performed or may also be non-regularly performed.

The evaluation executing unit 140 evaluates a person. Specifically, if a person-evaluation request is transmitted from the user terminal 20 to the person evaluation device 10, the evaluation executing unit 140 allows the user terminal 20 to display an input screen for specifying a person ID of a person to be evaluated and a program ID of an evaluation program used to evaluate the person to be evaluated. The input screen is described by, for example, a Hyper Text Markup Language (HTML).

Then, if the person ID and the program ID specified on the input screen is transmitted from the user terminal 20 to the person evaluation device 10, the evaluation executing unit 140 specifies the transmitted person ID as a person ID of a person to be evaluated and starts an evaluation program 125 associated with the transmitted program ID. Then, if the started evaluation program 125 outputs an evaluation result, the evaluation executing unit 140 allows the user terminal 20 to display an evaluation result screen including an evaluation result. The evaluation result screen is described by, for example, an HTML.

The exchanging of the information between the user terminal 20 and the person evaluation device 10 described above is only an example; therefore, any method can be used for exchanging the information. For example, the information may also be exchanged using an email or the information may also be exchanged in accordance with an unique protocol.

The recommendation program selecting unit 150 selects an appropriate combination of the evaluation programs 125 in order to evaluate a person. To select the appropriate evaluation programs 125, the recommendation program selecting unit 150 receives a person ID of a person to be evaluated, a category of the evaluation program 125, and the number of the evaluation programs 125 used for the combination.

Specifically, if a selection request for the appropriate evaluation program 125 that is used to evaluate a person is transmitted from the user terminal 20 to the person evaluation device 10, the recommendation program selecting unit 150 allows the input screen to display the user terminal 20. The input screen is described by, for example, an HTML. A person ID of a person to be evaluated, a category of the evaluation program 125, and the number of the evaluation programs 125 used for the combination can be specified on the input screen.

Then, if the information specified on the input screen is transmitted from the user terminal 20 to the person evaluation device 10, in accordance with the transmitted information, the recommendation program selecting unit 150 selects a combination of the evaluation programs 125 having a high coverage percentage and allows the user terminal 20 to display a selection result. The recommendation program selecting unit 150 includes a combination candidate creating unit 151, a coverage percentage calculating unit 152, and a selection result output unit 153 as processing units for displaying a combination of the evaluation programs 125 having a coverage percentage.

The combination candidate creating unit 151 extracts, from the evaluation program specification information, data that matches a category in which a value of the category is specified. If the value of the category is not specified, the combination candidate creating unit 151 extracts all data from the evaluation program specification information 124. Then, by combining the specified number of the programs ID of the extracted data, the combination candidate creating unit 151 creates combinations that can be created.

As described above, by narrowing down the evaluation programs in accordance with the specified category, it is possible to select a combination of the evaluation program that calculates an evaluation value that conforms to a user's intention.

The coverage percentage calculating unit 152 calculates a coverage percentage for each combination created by the combination candidate creating unit 151. Specifically, by extracting, from the event information 123, data that matches a person ID in which a value of the person ID is specified the coverage percentage calculating unit 152 acquires event data on a person to be evaluated.

Then, by checking the configuration state of the evaluation item of the event data against the evaluation program specification information 124, the coverage percentage calculating unit 152 confirms whether evaluation is executable for at least one evaluation program that is contained in each combination in accordance with the event data. The “evaluation is executable” mentioned here means that values are set in all of the evaluation items needed by the evaluation programs.

Then, from among the event data on persons to be evaluated, the coverage percentage calculating unit 152 calculates, as a coverage percentage, a percentage of event data in which evaluation is executable for at least one evaluation program that is contained in each combination.

The selection result output unit 153 allows the user terminal 20 to display, as a selection result, a program ID or a program name of the evaluation program, which is contained in a combination in which the highest coverage percentage is calculated, and the coverage percentage, and the like. A screen for displaying information on the result is described by, for example, an HTML.

When displaying that screen on the user terminal 20, the selection result output unit 153 may also allow the evaluation executing unit 140 to execute an evaluation program contained in a combination in which the highest coverage percentage is calculated and may also simultaneously display the acquired evaluation result. Furthermore, instead of displaying only information related to the combination in which the highest coverage percentage is calculated, the selection result output unit 153 may also display information related to a plurality of combinations in descending order of the calculated coverage percentages.

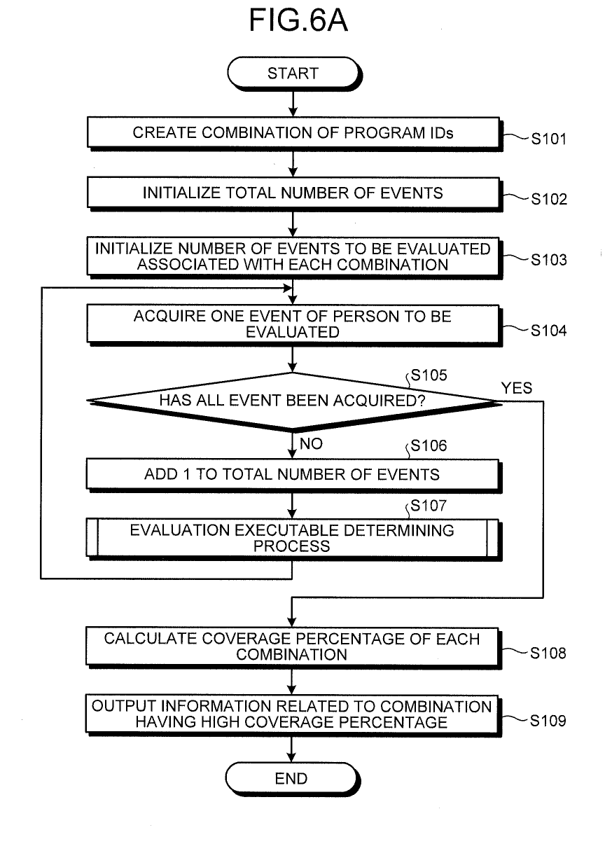

In the following, the flow of the combination selecting process performed by the person evaluation device 10 will be described with reference to FIG. 1. FIG. 6A is a flowchart illustrating the flow of a combination selecting process. As illustrated in FIG. 6A, first, the combination candidate creating unit 151 extracts data corresponding to the specified category from the evaluation program specification information 124 and creates all of the combinations including the specified number of programs ID (Step S101).

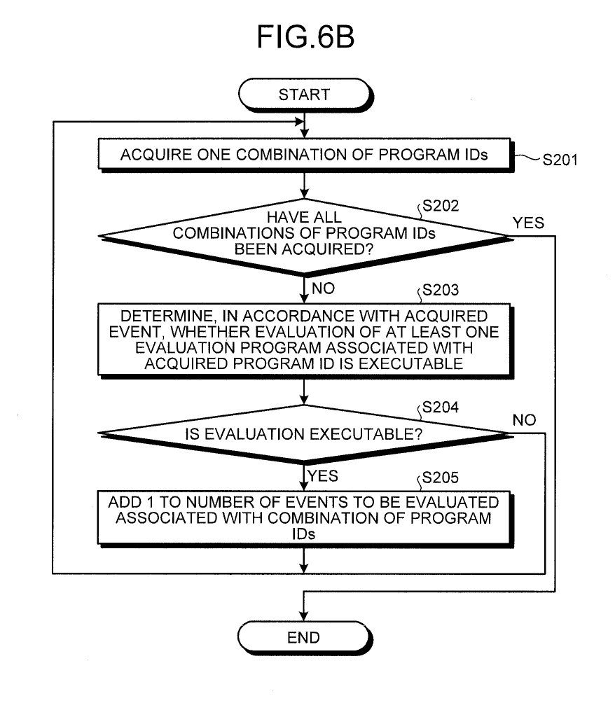

At this stage, for example, the data structure illustrated in FIG. 7 is created. The example illustrated in FIG. 7 is created based on the evaluation program specification information 124 illustrated in FIG. 5, where the “auction” in the category item is specified and “2” is specified as the number of program IDs used for a combination. In this case, by combining two sets of the program IDs from among the three program IDs, i.e., “PRG001”, “PRG002”, and “PRG004”, a combination of “PRG001, PRG002”, “PRG001, PRG004”, and “PRG002, PRG004” is created. Then, the number of events to be evaluated, which corresponds to the number of event data in which evaluation is executable, and a coverage percentage can be set.

Then, the coverage percentage calculating unit 152 initializes the total number of events representing the total number of event data on persons to be evaluated to 0 (Step S102) and initializes the number of events to be evaluated that is associated with each combination to 0 (Step S103).

The coverage percentage calculating unit 152 acquires, from the event information 123, a single event data that matches a person ID whose value is specified (Step S104). If the event data is acquired (No at Step S105), the coverage percentage calculating unit 152 adds 1 to the total number of events (Step S106).

The coverage percentage calculating unit 152 executes an evaluation executable determining process, which will be described later, and adds 1 to the number of events to be evaluated that is associated with each combination that includes the evaluation program with which evaluation is executable in accordance with the acquired event data (Step S107).

If the process related to the acquired event data is completed, the process returns to Step S104 and acquisition of the subsequent event data is performed. Then, after all of the event data on the persons to be evaluated is acquired and if new event data is not acquired (Yes at Step S105), the coverage percentage calculating unit 152 calculates a coverage percentage of each combination (Step S108).

The coverage percentage of each combination can be calculated by Equation below:

coverage percentage=the number of events to be evaluated associated with a combination/the total number of events

Then, the selection result output unit 153 allows the user terminal 20 to display, as the selection result, the information related to the combination having a high coverage percentage (Step S109).

FIG. 6B is a flowchart illustrating the flow of an evaluation executable determining process. As illustrated in FIG. 6B, the coverage percentage calculating unit 152 acquires one combination from among the combinations of the program IDs (Step S201). If a combination to be acquired remains and a combination can be acquired at this stage (No at Step S202), the coverage percentage calculating unit 152 determines, in accordance with the acquired event, whether the evaluation of at least one evaluation program associated with the acquired program ID is executable (Step S203).

If it is determined that the evaluation is executable (Yes at Step S204), the coverage percentage calculating unit 152 adds 1 to the number of events to be evaluated associated with the combination of the acquired program IDs (Step S205). If it is determined that the evaluation is not executable (No at Step S204), the number of events to be evaluated is not updated. The process related to the combination that is acquired in this way is completed, a process returns to Step S201 and the subsequent acquisition is performed.

The configuration of the person evaluation device 10 according to the embodiment illustrated in FIG. 1 is not limited thereto. Various modifications are possible as long as they do not depart from the spirit of the present invention. In the above explanation, the evaluation program 125 refers to the evaluation program specification information 124 in order to determine whether the evaluation is executable in accordance with the event data; however, the determination may also be performed by executing the evaluation program 125.

Specifically, the person evaluation device 10 creates information that has the same format as that of the event information 123, in which a random value is set in the same evaluation item as that of the event data that is used to determine the evaluation is executable, and allows the evaluation program 125 to execute the evaluation of the information. If the evaluation result acquired by changing the value of the evaluation item differs each other, it is possible to determine that the evaluation program 125 can execute the evaluation in accordance with the event data to be determined.

Furthermore, when calculating the coverage percentage, the reliability of a membership site of the acquisition source of the event may also be taken into consideration. When calculating the coverage percentage by taking into consideration the reliability of the membership site as illustrated in, for example, FIG. 2B, an item of the weighting value is added to the site information 121 and a weighting value is set in each membership site. The weighting value is a value representing the reliability of the event acquired from the membership site. A higher value is set as the reliability increases, whereas a smaller value is set as the reliability decreases, in which 1 is used as a reference value. For example, a small weighting value is set in an auction site in which the morality of users is low and an improper evaluation is given to an exhibitor or a winning bidder. In contrast, a high weighting value is set in an auction site in which the morality of users is high and proper evaluation is given to an exhibitor or a winning bidder.

Then, if it is determined that the evaluation is executable at Step S204 performed, at Step S205, in the evaluation executable determining process illustrated in FIG. 6B, the coverage percentage calculating unit 152 adds, instead of adding 1, a weighting value associated with the membership site of the acquisition source of the event to the number of events to be evaluated. With this configuration, a combination including an evaluation program that calculates an evaluation value having high reliability by using a large percentage of events acquired from the high reliable membership site can be easily selected by the recommendation program selecting unit 150.

In order to set the maximum value of the coverage percentage to 1 (100%), instead of setting the reference value of the weighting value for each membership site to 1, the maximum value of the weighting value may also be set to 1. Furthermore, in order to set the maximum value of the coverage percentage to 1 (100%), at Step S106 performed in the combination selecting process illustrated in FIG. 6A, instead of adding 1 to the total events, it may also be possible to add a weighting value associated with the membership site of the acquisition source of the event. Furthermore, a user who makes a request for the combination selecting process may also specify, for each membership site, a weighting value.

Furthermore, a function identical to that of the person evaluation device 10 can be implemented by installing a function included in each of the processing units in the person evaluation device as software and causing a computer to execute it. In the following, an example of a computer that executes a recommendation program selecting program 1071 in which the function included in the recommendation program selecting unit 150 is installed as software will be described.

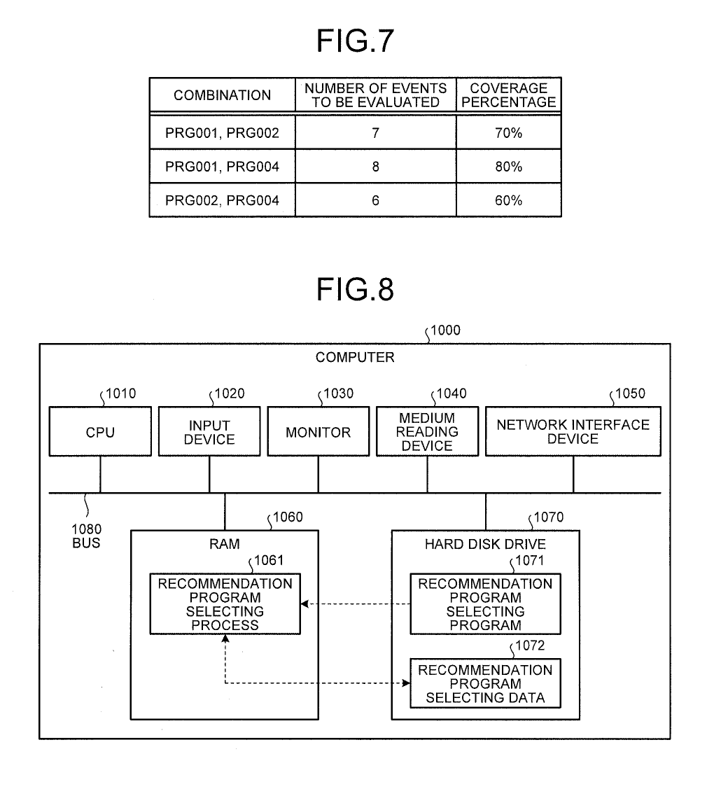

FIG. 8 is a functional block diagram illustrating a computer 1000 that executes the recommendation program selecting program 1071. The computer 1000 includes a central processing unit (CPU) 1010 that executes various computing processes, an input device 1020 that receives data from a user, a monitor 1030 that displays various kinds of information, a medium reading device 1040 that reads a program from a recording medium, a network interface device 1050 that receives/transmits data between other computers via a network, random access memory (RAM) 1060 that temporality stores therein various kinds of information, and a hard disk drive 1070, which are all connected via a bus 1080.

The hard disk drive 1070 stores therein the recommendation program selecting program 1071 having the same function as that performed by the recommendation program selecting unit 150 illustrated in FIG. 1 and recommendation program selecting data 1072 corresponding to various data stored in the storing unit 120 illustrated in FIG. 1. The recommendation program selecting data 1072 may also appropriately be separated and be stored in another computer connected via the network.

The CPU 1010 reads the recommendation program selecting program 1071 from the hard disk drive 1070 and loads it in the RAM 1060, and thus the recommendation program selecting program 1071 functions as a recommendation program selecting process 1061. Then, the recommendation program selecting process 1061 appropriately loads, in an area of the RAM 1060 allocated to the recommendation program selecting process 1061, information or the like that is read from the recommendation program selecting data 1072 and executes various data processes on the basis of the loaded data.

The recommendation program selecting program 1071 is not always stored in the hard disk drive 1070. For example, the computer 1000 may reads the program stored in a storage medium, such as a CD-ROM, and executes the recommendation program selecting program 1071. Alternatively, the recommendation program selecting program 1071 may also be stored in another computer (or a server) connected to the computer 1000 via, for example, a public circuit, the Internet, a local area network (LAN), a wide area network (WAN), or the like. The computer 1000 then reads and executes the program from the above. The computer 1000 then reads and executes the programs from the flexible disk or the like described above.

According to an aspect of a person evaluation device, a person evaluation method, and a person evaluation program disclosed in the present invention, an advantage is provided in that a person to be evaluated can be fairly evaluated.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer readable storage medium having stored therein a person evaluation program causing a computer to execute a process comprising:
collecting, from a plurality of membership sites, event data in which activities performed by members on the membership sites are recorded;
creating a combination of evaluation programs each of which calculates an evaluation value of a person to be evaluated in accordance with a value that is set in a predetermined item contained in evaluation items contained in the event data;
calculating, for each combination, a coverage percentage that represents a percentage that is used to calculate the evaluation value by at least one evaluation program in which event data, from among the event data collected at the collecting, related to a member associated with the person to be evaluated is included in the combination created at the creating; and
outputting information related to the evaluation program included in the combination that is selected in accordance with the coverage percentage calculated at the calculating.

2. The non-transitory computer readable storage medium according to claim 1, wherein the calculating calculates the coverage percentage in accordance with the total value obtained by weighting, from among the event data related to the member associated with the person to be evaluated, in accordance with the reliability that is set for each of the membership sites corresponding to a collecting source of each of the event data, the number of the event data, which is used to calculate the evaluation value by at least one evaluation program included in the combination created at the creating, and calculates the coverage percentage in accordance with the total number of the event data each of which is related to the member associated with the person to be evaluated.

3. The non-transitory computer readable storage medium according to claim 1, wherein the outputting allows the evaluation program included in the selected combination to calculate the evaluation value of the person to be evaluated and outputs the evaluation value.

4. The non-transitory computer readable storage medium according to claim 1, wherein the calculating determine whether the event data is used to calculate the evaluation value by the evaluation program by executing the evaluation program on event data having a value that is set in the same evaluation item as that contained in the event data.

5. A person evaluation device comprising:
a collecting unit that collects, from a plurality of membership sites, event data in which activities performed by members on the membership sites are recorded;
a combination candidate creating unit that creates a combination of evaluation programs each of which calculates an evaluation value of a person to be evaluated in accordance with a value that is set in a predetermined item contained in evaluation items contained in the event data;
a coverage percentage calculating unit that calculates, for each combination, a coverage percentage that represents a percentage that is used to calculate the evaluation value by at least one evaluation program in which event data, from among the event data collected by the collecting unit, related to a member associated with the person to be evaluated is included in the combination created by the combination candidate creating unit; and
a selection result output unit that outputs information related to the evaluation program included in the combination that is selected in accordance with the coverage percentage calculated by the coverage percentage calculating unit.

6. The person evaluation device according to claim 5, wherein the coverage percentage calculating unit calculates the coverage percentage in accordance with the total value obtained by weighting, from among the event data related to the member associated with the person to be evaluated, in accordance with the reliability that is set for each of the membership sites corresponding to a collecting source of each of the event data, the number of the event data, which is used to calculate the evaluation value by at least one evaluation program included in the combination created by the combination candidate creating unit, and calculates the coverage percentage in accordance with the total number of the event data each of which is related to the member associated with the person to be evaluated.

7. A person evaluation method comprising:
collecting, from a plurality of membership sites, event data in which activities performed by members on the membership site are recorded;
creating a combination of evaluation programs each of which calculates an evaluation value of a person to be evaluated in accordance with a value that is set in a predetermined item contained in evaluation items contained in the event data;
calculating, for each combination, a coverage percentage that represents a percentage that is used to calculate the evaluation value by at least one evaluation program in which event data, from among the event data collected at the collecting, related to a member associated with the person to be evaluated is included in the combination crated at the creating; and
outputting information related to the evaluation program included in the combination that is selected in accordance with the coverage percentage calculated at the calculating.

8. The person evaluation method according to claim 7, wherein the calculating calculates the coverage percentage in accordance with the total value obtained by weighting, from among the event data related to the member associated with the person to be evaluated, in accordance with the reliability that is set for each of the membership sites corresponding to a collecting source of each of the event data, the number of event data, which is used to calculate the evaluation value by at least one evaluation program included in the combination created at the creating, and calculates the coverage percentage in accordance with the total number of the event data each of which is related to the member associated with the person to be evaluated.
